(19) United States
(12) Patent Application Publication
(10) Pub. No.: US 2005/0053893 A1
(43) Pub. Date: Mar. 10, 2005

(54) Orthodontic torque loss-free bracket slot with corresponding arch

(76) Inventor: Ines Graf, Koln (DE)

Correspondence Address: LAW OFFICES OF WILLIAM H. HOLT, 12311 HARBOR DRIVE, WOODBRIDGE, VA, 22192, US

(21) Appl. No.: 10/658,779

(22) Filed: Sep. 10, 2003

(51) Int. Cl. A61C 3/00

(52) U.S. Cl. 433/16; 433/20

(57) ABSTRACT

Orthodontic devices including brackets for being attached to a tooth and each having particularly designed slots formed therein for receiving particularly shaped wire arches for avoiding loss of torque.

### BACKGROUND OF THE INVENTION

It is known that orthodontics deal with the diagnosis, prevention and treatment of the morphological and functional malformation of teeth. One task of orthodontics is to move teeth by applying mechanical forces, using orthodontic appliances, in the in the bones of the maxilla and/or mandible. Movable appliances and fixed appliances, i.e., so-called multi-band devices, are both known for the purpose. The basic components, or attachments, of these fixed, multi-band devices are so-called attachments and include bands, brackets, arches, ligatures, elastics and springs, known, as follows:
a. Bands: usually consist of preformed, generally 0.1 millimeter (mm) thick metal rings made of stainless, nickle-chromium steel, and having a lock either soldered or welded from the outside and adapted to be cemented on the molar teeth.
b. Brackets: usually consist of stainless, nickel-chromium steel, but can also be made of plastics and ceramics. Numerous bracket designs are available, usually with an 0.018″ wide slot, or with an 0.02″ wide slot. Principally, it is reasonable to differentiate between “edgewise” brackets and “Begg” brackets. The “Begg” bracket features a narrow mesiodistal slot in which the exclusively used round arch, i.e., of round wire, lies loosely secured by a pin. “Edgewise” brackets feature a slot with rectangular cross-section which has its wider extension in the horizontal plane. The bracket may be embodied as a single bracket or as a twin bracket. Round wire arches or square wire arches may be used. Standardized brackets and programmed edgewise brackets are available. In standard edgewise brackets, the slot is always embodied centrally and at a fixed distance to the bracket base, and information about movement must be incorporated in the arch. The slot position and its distance to the bracket base of programmed edgewise brackets is different for each tooth, and information is incorporated in the bracket.
c. Arch: is the wire which runs through the bracket slot. The arch may be made of stainless steel, or special alloys, and is available in different cross-sections, types and dimensions.
d. Ligatures: are devices that are available as wire or elastic ligatures. These are used to fix the arch in the brackets.
e. Elastics: are rubber rings of different size and thickness. The rubber rings may be suspended either intramaxillary, i.e., between teeth of one and the same jawbone, or intermaxillary, i.e., between teeth of maxilla and mandible.

In the course of further progress in the dental field brought about by the use of composite materials, the brackets were no longer welded on the bands but now may be glued directly on the tooth surface with composite cement. The rigidly cemented brackets provide for a point of application of force in the region of the crown of the tooth, which ensures that the intentional tooth movement by means of continuous or segmented, round and/or square arches of different diameters, wire quality and auxiliary means, is executed until the desired tooth position is achieved. Prior to its insertion into the bracket, the elastic wire arch is bent and/or twisted, which produces in the wire arch a restoring force which acts on the corresponding tooth and shifts, turns and inclines it in any desired direction, depending on the type of wire arch and positioning of the bracket slot.

Conventional orthodontics brackets and wire arches do not provide for a 100% fill-out of the bracket slots; as a result, the wire arches may twist in the bracket slots causing a loss in torque, usually referred to as the so-called “torque play.” Torque is a force momentum about a neutral axis, in the present environment a movement of the root of a tooth, with a center of resistance in the upper third of the root of the tooth, about a point of rotation in the region of the crown of the tooth. Information about the torque is programmed into the base of each bracket, or by the tilt in the bracket slots. Different torque values are required for different teeth; depending upon the system; they are in the order between +22° and −30°.

Because of the torque loss and/or torque play, a great part of information about the torque. i.e., nominal torque, embodied in the brackets is lost, and the result is a difference between nominal and effective torques. The torque loss/torque play renders ineffective part of the torque incorporated in the bracket. The effective torque of conventional brackets is calculated according to the following formulae:
T_{eff}=T−Φ
Φ=arc cos(h−2R)/D−arc cos(B−2R)/D
D=(b−2R)²+(h−2R)²
where T_{eff}=effective torque, T=nominal torque; Φ=theoretical torque play;
h=height of square wire; b=width of square wire; B=slot width;
R=radius of edge rounding; D=diagonal measure minus edge rounding;
(angles in degrees, distances in millimeters)

In the prior art, the use of a wire arch which fills the bracket slot almost completely and thus would have a low torque loss and/or torque play is impossible, firstly, because of the strong forces which cause resorption of the root of the tooth and, secondly, because of teeth which are still rotated and tilted. Complete alloying of the wire arch in the bracket slot would be impossible in this phase.

### SUMMARY OF THE INVENTION

The invention provides for a solution to the problem of torque loss/torque play.

It is an object of the invention to reduce the torque loss/torque play to zero even for the use of wire arches which do not fill the slot in the bracket.

### BRIEF DESCRIPTION OF THE DRAWINGS

FIG. 1A shows the root and crown of a tooth having a bracket affixed to the crown.

FIG. 1B shows an enlarged profile of the bracket of FIG. 1A.

FIG. 2A shows the root and crown of a tooth having a modified bracket affixed to the crown.

FIG. 2B shows an enlarged profile of the modified bracket of FIG. 2A.

FIG. 3 is a fragmentary, perspective view showing a pentagon-shaped, vertical cross-section of a first wire arch.

FIG. 4 is a fragmentary, perspective view showing a pentagon-shaped, vertical cross-section of a second wire arch.

FIGS. 5A through 5F, inclusive, show templates typical of brackets having slots 0.028″ in height, and arches with differing dimensions disposed within the slots.

FIGS. 6A through 6D, inclusive, show templates typical of brackets having slots 0.025″ in height, and arches with differing dimensions disposed within the slots.

### DETAILED DESCRIPTION OF THE PREFERRED EMBODIMENTS

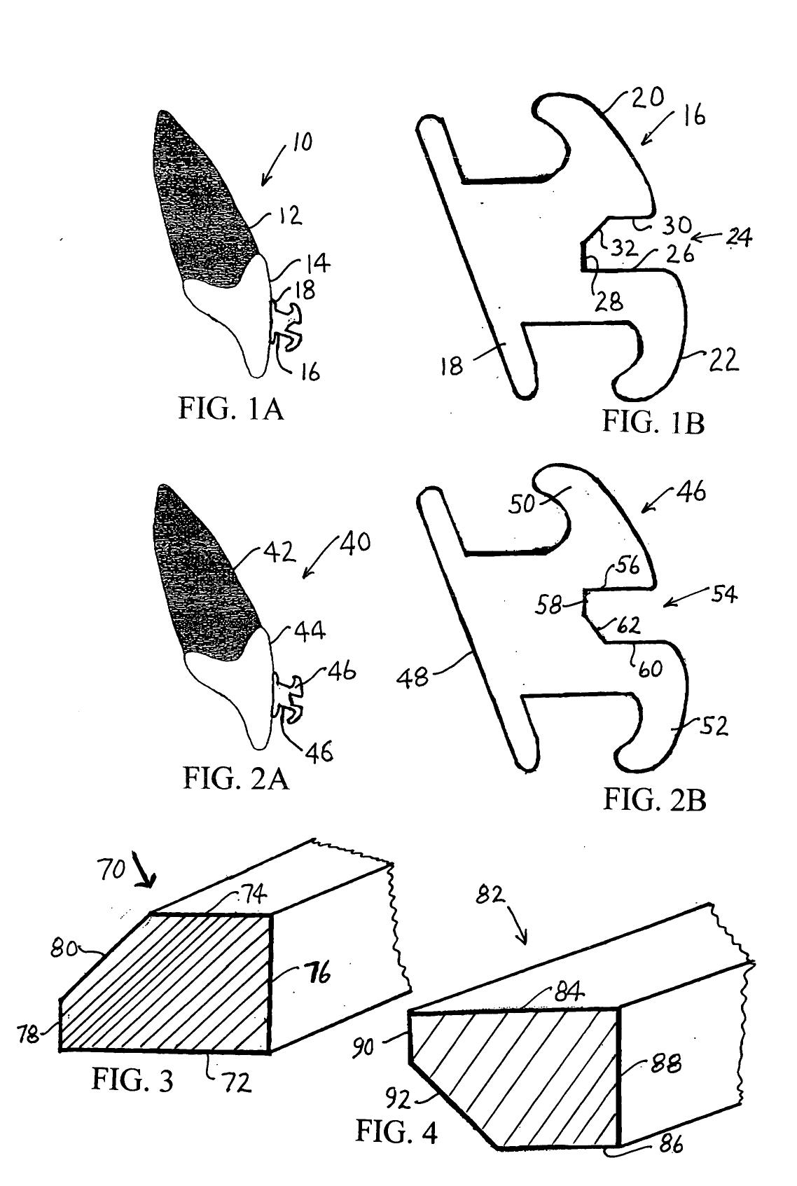

Referring to the drawings in detail, FIG. 1A illustrates a tooth, generally indicated by the numeral 10, having a root 12 and a crown 14. A bracket 16 is shown as being affixed to the crown 14 such as with composite cement, not shown.

FIG. 1B shows an enlarged profile of bracket 16 as including a bracket base 18, bracket wings 20 and 22 and a bracket slot 24 opening outwardly at the side of the bracket 16 opposite from the base 18. Slot 24 includes a straight, generally horizontal side 26, a straight, generally vertical side 28, a straight, upper horizontal side 30 which is spaced from vertical side 28 by a canted side 32 that is slanted 45° forming a top angle at the inner portion of the slot 24 toward the base 18 facing the tooth 10.

FIG. 2A illustrates a tooth, generally indicated by the numeral 40, having a root 42 and a crown 44. A bracket 46 is shown as being affixed to the crown 44 such as with composite cement, not shown.

FIG. 2B shows an enlarged profile of bracket 46 as including a bracket base 48, bracket wings 50 and 52 and a bracket slot 54 opening outwardly at the side of the bracket 46 opposite from the base 48. Slot 54 includes a straight, generally horizontal, top side 56, a straight, generally vertical side 58, a straight, lower horizontal side 60 which is spaced from vertical side 58 by a canted side 62 that is slanted 45° forming a bottom angle at the inner portion of the slot 54 toward the base 48 facing the tooth 40.

FIG. 3 shows a fragmentary, perspective view of a lateral cross-section of a first form of wire arch 70 having a bottom edge 72 extending the width of the arch 70, a top edge 74, a first vertical edge 76 extending the height of the arch 70, a short vertical edge 78, and a canted edge 80 which is slanted at 45° between edges 74 and 78. The resulting cross-section of wire arch 70 forms an irregular pentagon. It is readily seen that wire arch 70 is to be used in combination with bracket 16 as shown in FIGS. 1A and 1B.

FIG. 4 shows a fragmentary, perspective view of a lateral cross-section of a second form of wire arch 82 having a top edge 84 extending the width of the arch 82, a bottom edge 86, a first vertical edge 88 extending the height of the arch 82, a short vertical edge 90, and a canted edge 92 which is slanted at 45° between edges 86 and 90. The resulting cross-section of wire arch 82 forms an irregular pentagon. It is readily seen that wire arch 82 is to be used in combination with bracket 46 as shown in FIGS. 2A and 2B.

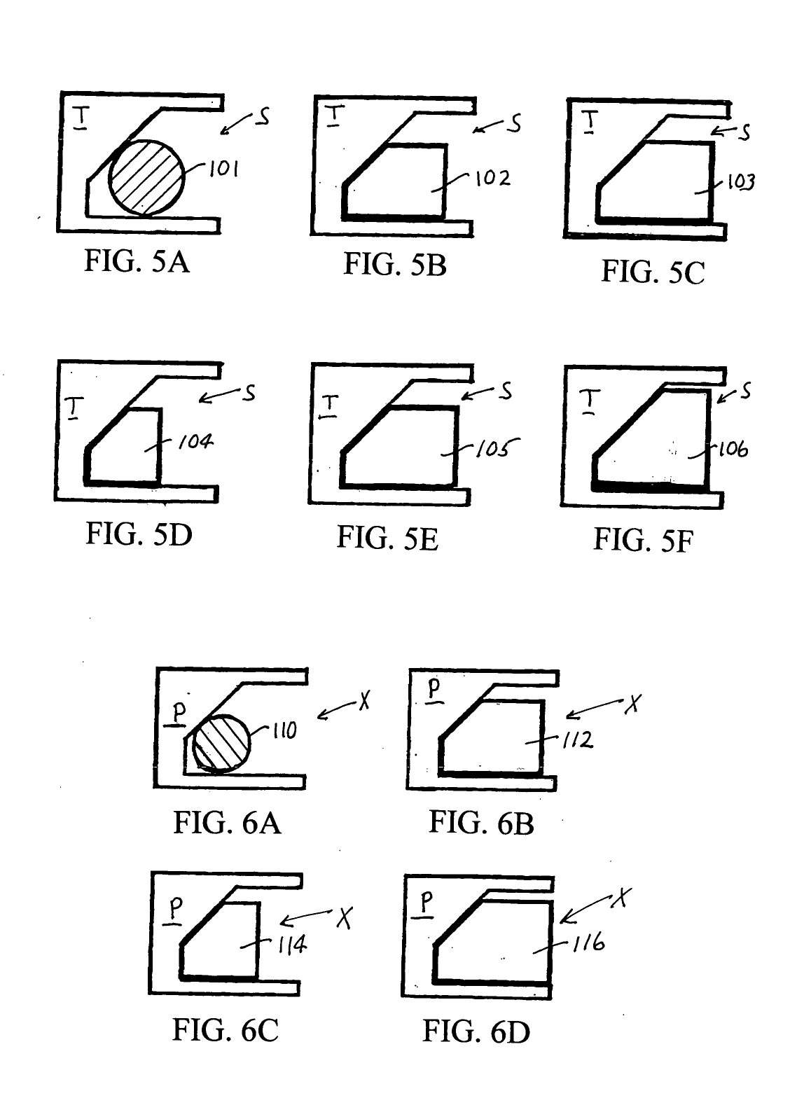

FIGS. 5A through 5F show a series of identical templates T, representing typical brackets, each having a slot generally indicated by the letter S and having a typical height of 0.022″ and a typical width of 0.028″ for cooperation with a wire arch having a circular cross-section or a pentagon shape typical of arch 70, as is shown in FIG. 3. FIG. 5A shows a circular wire arch 101 having a diameter of 0.016″. FIG. 5B shows a pentagon shaped wire arch 102 having a height of 0.016″ and a width of 0.022″. FIG. 5C shows a pentagon shaped wire arch 103 having a height of 0.019″ and a width of 0.025″. FIG. 5D shows a pentagon shaped wire arch 104 having a height of 0.016″ and a width of 0.016″. FIG. 5E shows a pentagon shaped wire arch 105 having a height of 0.017″ and a width of 0.025″. FIG. 5F shows a pentagon shaped wire arch 106 having a height of 0.021″ and a width of 0.025″.

Likewise, FIGS. 6A through 6D show a series of templates P, representing typical brackets, each having a slot X having a typical height of 0.018″ and a typical width of 0.025″ for cooperation with a wire arch having a circular cross-section or a pentagon shape typical of arch 70 as is shown in FIG. 3. FIG. 6A shows a circular wire arch 110 having a diameter of 0.012″. FIG. 6B shows a pentagon shaped wire arch 112 having a height of 0.016″ and a width of 0.022″. FIG. 6C shows a pentagon shaped wire arch 114 having a height of 0.016″ and a width of 0.016″. FIG. 6D shows a pentagon shaped wire arch 116 having a height of 0.017″ and a width of 0.025″.

It will be understood by those of ordinary skill in this art that brackets as shown in FIGS. 2A and 2B are to be used with pentagon shaped wire arches as shown in FIG. 4 in a manner as described above with respect to FIGS. 5 and 6.

From the foregoing description, it will be apparent to those skilled in the art that various forms of the invention minimize or eliminate loss of torque with respect to the improved orthodontic devices, and it is to be understood that the devices, as disclosed, are representative of the inventive features which are set out in the appended claimed subject matter.

1. A combination of an orthodontic bracket and a corresponding arch, said bracket and said arch cooperating for influencing the position of a patient's teeth, said combination being characterized in that said bracket includes a first side adapted for being attached to a patient's tooth, a slot formed in said bracket and extending toward said first side, said slot including a plurality of planar surfaces disposed at fixed angles to each other; said arch having a plurality of surfaces disposed at angles which match said fixed angles of said slot whereby there is no loss of torque between said bracket and said arch.

2. The combination as defined in claim 1 wherein said slot includes a canted side that is slanted at an angle of 45° forming an angle at an inner portion of said slot.

3. The combination as defined in claim 2 wherein said angle is formed at an upper portion of said slot.

4. The combination as defined in claim 2 wherein said angle is formed at a lower portion of said slot.

5. The combination of claim 1 wherein said plurality of surfaces of said arch define a wedge for interfitting with said plurality of planar surfaces of said slot for precluding rotation of said arch within said slot.

6. The combination of claim 5 wherein said arch includes parallel top and bottom sides and an intermediate side slanted at 45° with respect to said parallel top and bottom sides.

7. The combination of claim 6 wherein said intermediate side intersects with said top side.

8. The combination of claim 6 wherein said intermediate side intersects with said bottom side.

9. The combination of claim 1 wherein said arch in cross-section forms a pentagon.
